(19) United States
(12) Patent Application Publication
(10) Pub. No.: US 2026/0278386 A1
(43) Pub. Date: Sep. 17, 2026

(54) GENERATING TOKENS USING ONE OR MORE NEURAL NETWORKS

(71) Applicant: NVIDIA Corporation, Santa Clara, CA (US)

(72) Inventors: Teodor-Dumitru Ene, Tulsa, OK (US); Vikram Sharma Mailthody, Urbana, IL (US); Kyle Kranen, Menlo Park, CA (US)

(21) Appl. No.: 19/180,502

(22) Filed: Apr. 16, 2025

Related U.S. Application Data
(60) Provisional application No. 63/771,557, filed on Mar. 13, 2025.

(51) Int. Cl. G06N 3/0895

(52) U.S. Cl. CPC G06N 3/0895

(57) ABSTRACT

Apparatuses, systems, and techniques to cause one or more neural networks to perform one or more prefill operations on a token of a set of tokens before the set of tokens is completely generated. In at least one embodiment, a processor comprises circuitry to cause one or more first neural networks to begin generating a set of tokens and cause one or more second neural networks to perform one or more prefill operations on a token of the set of tokens before the set of tokens is completely generated.

### CROSS REFERENCE TO RELATED APPLICATIONS

This application claims the benefit of U.S. Provisional Application No. 63/771,557, filed Mar. 13, 2025, entitled “GENERATING TOKENS USING ONE OR MORE NEURAL NETWORKS,” the entire contents of which is incorporated herein by reference.

### TECHNICAL FIELD

At least one embodiment pertains to processing resources used to generate tokens using one or more neural networks.

### BACKGROUND

Generating tokens using neural networks is an important task in various contexts. In some computing systems, tokens are generated in stages, with subsequent stages using tokens generated in previous stages. In such computing systems, generating the tokens in an efficient manner can be a difficult task. The amount of memory, time, or computing resources used to generate tokens using one or more neural networks can be improved.

### BRIEF DESCRIPTION OF THE DRAWINGS

FIG. 1 is a block diagram of an example of one or more agents, in accordance with at least one embodiment;

FIG. 2 is a block diagram of an example dataflow from decode of one stage to another agent performing prefill for a next stage, in accordance with at least one embodiment;

FIG. 3 is a block diagram of an example decode matrix allowing prefill of stage N+1 to be performed during decode of stage N, in accordance with at least one embodiment;

FIG. 4 is a block diagram of an example set of agent tasks performed during each time slot of an example workflow, in accordance with at least one embodiment;

FIG. 5 is a flowchart of an example process to perform decode and prefill operations, in accordance with at least one embodiment;

FIG. 6A is a block diagram of an example generative language model system suitable for use in implementing at least some embodiments of the present disclosure;

FIG. 6B is a block diagram of an example generative language model that includes a transformer encoder-decoder suitable for use in implementing at least some embodiments of the present disclosure;

FIG. 6C is a block diagram of an example generative language model that includes a decoder-only transformer architecture suitable for use in implementing at least some embodiments of the present disclosure;

FIG. 7 is a block diagram of an example computing device suitable for use in implementing at least some embodiments of the present disclosure; and

FIG. 8 is a block diagram of an example data center suitable for use in implementing at least some embodiments of the present disclosure.

### DETAILED DESCRIPTION

In an example, techniques described herein improve performance of language model (e.g., large language model (LLM)) systems by, based on a request from an endpoint (e.g., a user, computing device, etc.), causing one or more first neural networks to begin generating a set of tokens, and then causing one or more second neural networks to perform prefill operations on tokens of the set of tokens as the tokens are being generated. The one or more second neural networks may then perform one or more decode operations to generate a response to a user. This addresses challenges faced in language model systems, particularly as part of generating responses to requests that may require multiple LLMs, in which a particular LLM may completely generate a set of tokens before providing the set of tokens to another LLM to perform prefill operations on the set of tokens. Techniques described herein may improve language model systems by obtaining a request from an endpoint (e.g., user, etc.) that may require multiple LLMs and/or token generation steps, determining storage required for generated tokens, causing one or more first LLMs to generate a set of tokens in the determined storage, and causing a second LLM to perform prefill operations on tokens of the set of tokens as they are being generated and stored in the determined storage. In this manner, the second LLM may perform prefill operations without having to wait until the one or more first LLMs complete generation of the set of tokens. It should be noted that, while various embodiments described herein may be in reference to one or more LLMs, the one or more LLMs may be any suitable language models such as those described herein.

An LLM system may implement one or more agents to generate responses to requests. Each agent may be an instance of the LLM assigned to perform a specific task. An agent may perform prefill operations to generate information of tokens and decode operations to generate new tokens based on the generated information. Prefill operations may require the outputs of a previous iteration (e.g., a prior stage, layer, slice, time slot, and/or any other designation of prior completed decode operations) and/or other provided inputs to be prepared for further decode stages. This preparation may include attention computation, cache creation, and/or any other required processes to be performed on input data before decoding can be performed. Performing LLM inferencing on a set of input data (e.g., to perform decode operations) may be the process by which an LLM generates tokens and/or other output data to either be iterated upon again, and/or output as the outputs of the LLM.

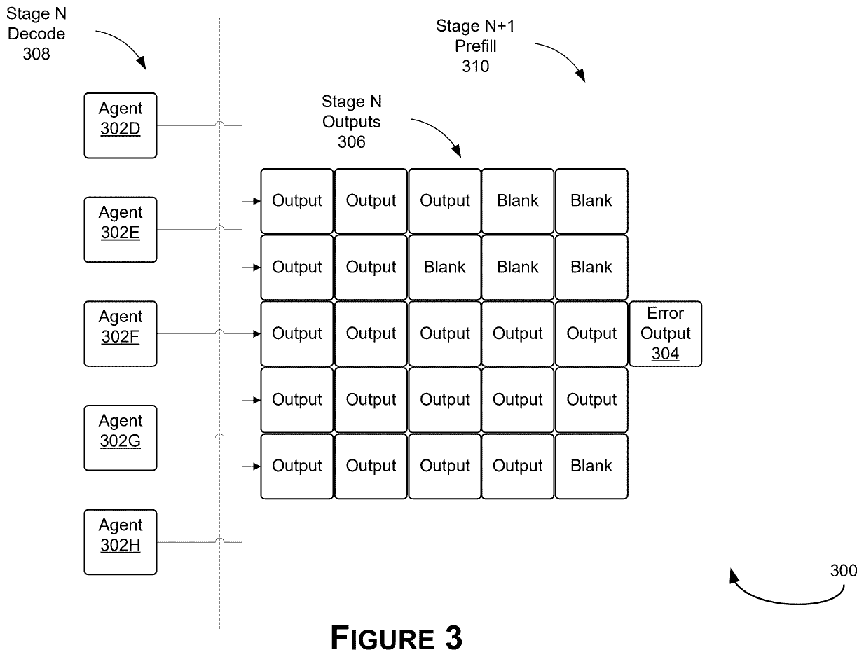

The LLM system may stream outputs of each agent of a decode stage to a matrix, also referred to as a grid (e.g., prefill matrix, see example in FIG. 3), which may allow some outputs of those agents to be processed by prefill operations for a next stage in parallel with further decode. The matrix may be sized to accommodate for expected decode output data sizes (e.g., a number of tokens to be output), allowing agents of a decode stage to output, at the end of each timestep, output data (e.g., tokens) into the matrix. An agent may then perform prefill operations on the provided outputs during a next timestep, while other agents may perform decode operations to fill in a next output slot in the matrix. In some examples, prefill for a next stage may be performed while decode of the current stage is performed, reducing the delay between decode stages and overall performance time. Once all outputs are provided and prefill operations are performed, a stitch operation may be performed. As prefill is performed before all outputs are provided, attention between those outputs may not be computed until after, at which time the output matrix may be processed through one or more stitching operations such as described herein to provide this attenuation. The outputs may then be decoded in a next stage. This process may be performed iteratively until an end condition is reached.

Techniques described herein may include processes to compute prefill of stage N+1 concurrently with the ongoing decode operations of stage N. By pre-establishing an input matrix for the prefill computation, the LLM system can immediately populate the matrix with streamed outputs from decode agents, thus eliminating the latency cost associated with waiting for all outputs to be concatenated, resulting in a significant reduction in workflow latency, enabling faster and more efficient processing in multi-stage agentic LLM workflows.

In the preceding and following description, numerous specific details are set forth to provide a more thorough understanding of at least one embodiment. However, it will be apparent to one skilled in the art that the inventive concepts may be practiced without one or more of these specific details.

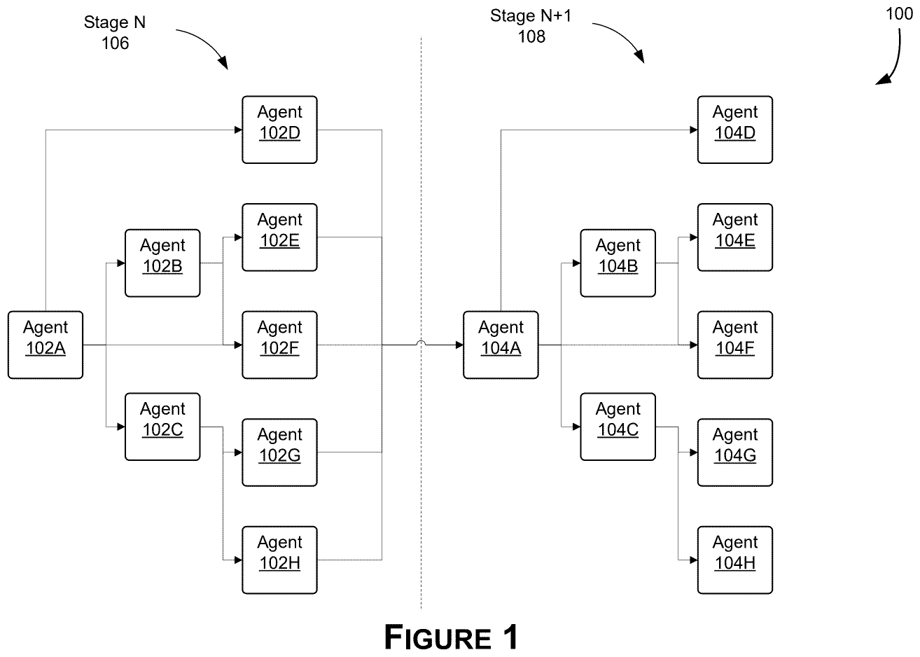

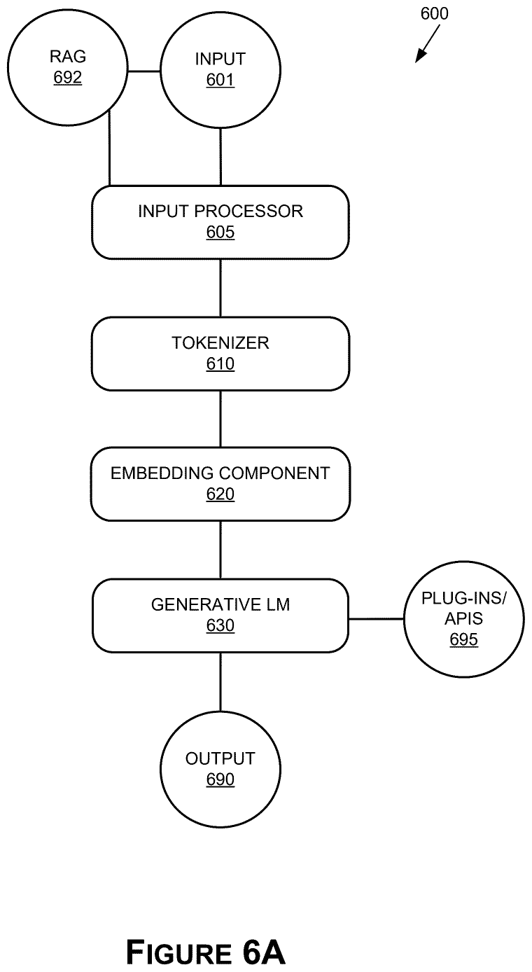

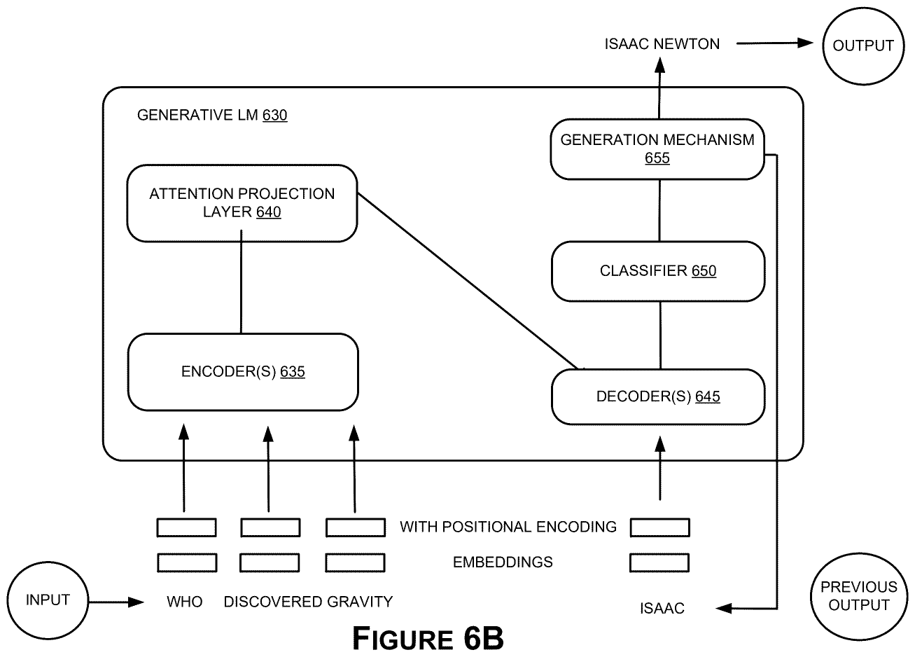

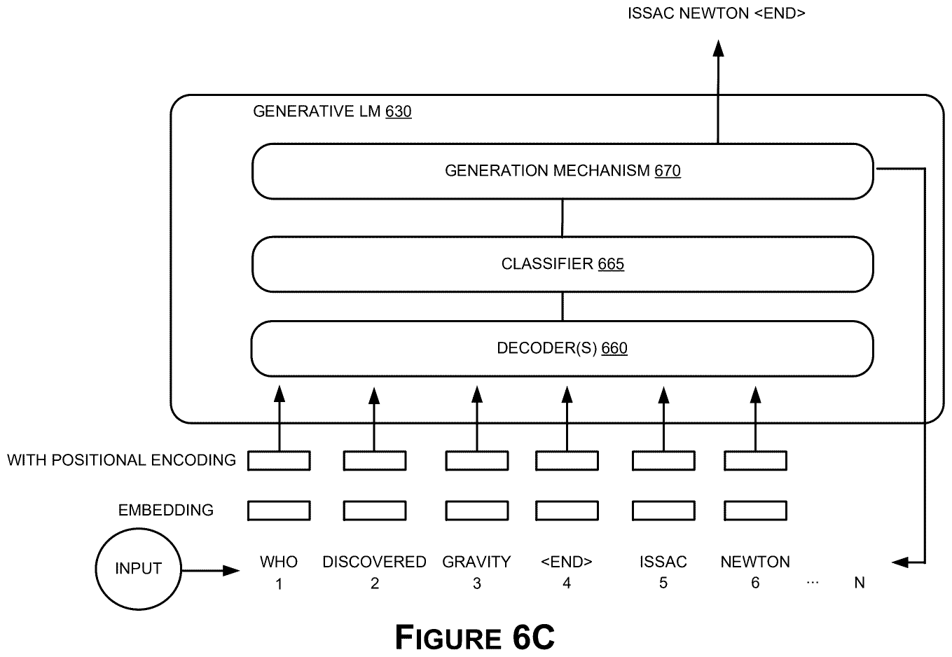

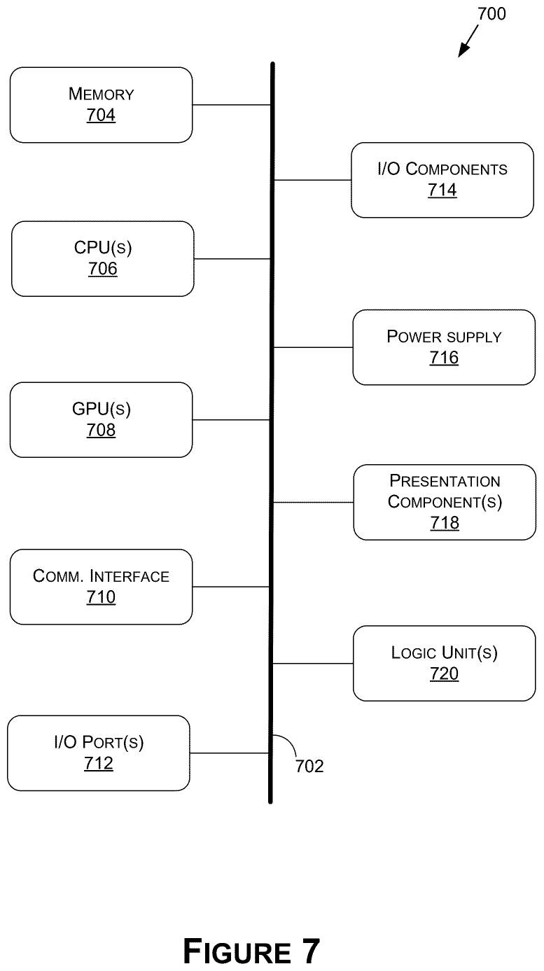

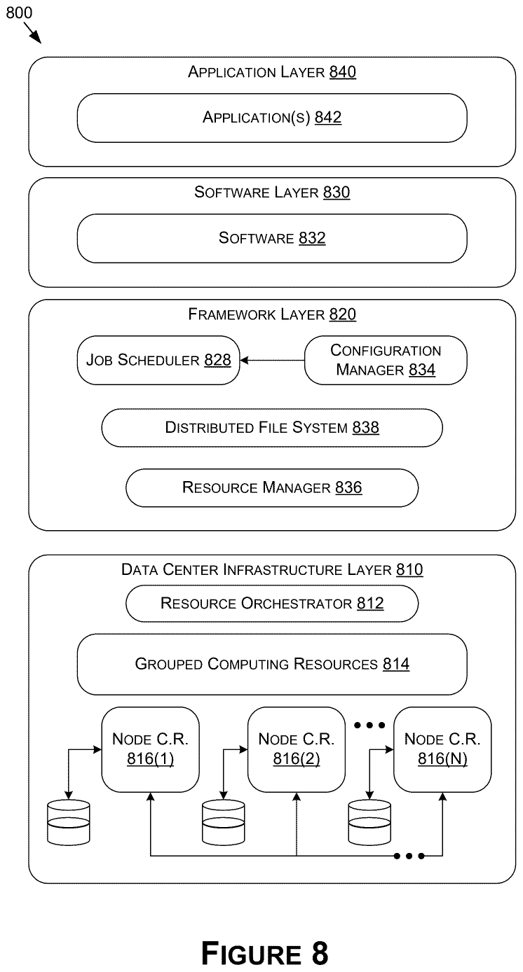

With reference to FIG. 1, FIG. 1 is an example of one or more agents, in accordance with at least one embodiment;. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 6A-6C), one or more computing devices or components thereof (e.g., as described in FIG. 7), and/or one or more data centers or components thereof (e.g., as described in FIG. 8).

FIG. 1 may include one or more agents 102A-102H (referred to as agents 102), agents 104A-104H (referred to as agents 104), stage N 106, and/or stage N+1 108. In some examples, the agents 102 may be the agents 104. The agents 102 and/or 104 may be part of an LLM system that may generate responses to user requests. The agents 102 may be performing one or more operations of stage N 106, which may refer to a stage of a process of the LLM system to generate a response to a request. The agents 104 may be performing one or more operations of stage N+1 108, which may refer to a subsequent stage of the process of the LLM system to generate the response to the request. In some embodiments, there may be any number of similar stages before stage N 106 and/or after stage N+1 108, as required by the LLM system. In some embodiments, all stages (e.g., stage N 106, stage N+1 108, and/or any other included stages) comprise a workflow for performance of an associated LLM, in which stages may be performed sequentially, in parallel, and/or in any suitable manner.

In at least one embodiment, an agent such as those described herein is a collection of hardware and/or software computing resources with instructions that, when performed or otherwise executed, cause performance of one or more processes such as those described in connection with FIGS. 1-5. In some examples, an agent is a software program, application, or module that can be performed or otherwise executed on computer hardware. An agent, also referred to as a neural network, may be an instance of an LLM or otherwise implement an LLM. Agents 102 and/or 104 may be one or more agents, wherein said agents receive inputs, perform related processing, and provide outputs to an indicated location in parallel with other agents, such as to another agent and/or to memory (e.g., a grid in memory). Agents 102 and/or 104 may be defined as execution slices within a stage of a multi-stage LLM workflow, wherein each agent represents an invocation of the LLM dedicated to a specific task, such as data retrieval and processing, natural language generation, data analysis and interpretation, and/or any other required task for a given workflow. Agents 102 and/or 104 may perform operations as part of a stage of a workflow (e.g., stage N 106 and/or stage N+1 108), wherein each stage is an iterative portion of the workflow. Agents between said stages (for example, agent 102A and agent 104A) may perform a same function, but on differing inputs during differing stages. As an illustrative example, agents 102D-102H of stage N 106 provide outputs to an agent 104A of stage N+1 108, which then performs processing (e.g., performing ordering and data analysis) before providing its outputs to agents 104B and 104C. Outputs of agents 102D-102H can be ordered into an output matrix (e.g., matrix of FIG. 3) to allow preparation for a next stage to be performed while outputs are still being generated.

In some examples, a prefill operation such as described herein refers to one or more operations of processing an input (e.g., obtaining an input prompt and tokenizing the prompt into a sequence of tokens, which may be numerical representations of words or sub-words); transforming tokens into vectors using embedding layers, in which the vectors may encode semantic information about the tokens; setting up or otherwise generating an internal state based on the input tokens, which may include initializing memory cells and/or attention mechanisms that will be used during decoding; and/or using attention layers to process relevant parts of the input to generate data or other information to understand or otherwise indicate context and relationships between tokens. In some embodiments, a decode operation such as described herein refers to one or more operations of generating tokens one by one, which may include starting from the initial state set up during the prefill stage; selecting or otherwise generating tokens using techniques like greedy decoding, beam search, and/or sampling, which can be based on generated distributions; after generating tokens, updating the internal state to incorporate the new token into the context, which can involve updating memory cells and attention weights; repeating processes of token generation and state updates until a stopping criterion is met, such as reaching a maximum length or generating an end-of-sequence token; and/or converting generated tokens into human-readable text, forming the final output sequence.

The LLM system may cause the agents 102D-102H to begin generating a set of tokens, such as part of stage N 106. The LLM system may cause the agents 102D-102H to generate the set of tokens by causing the agents 102D-102H to perform one or more prefill operations and one or more decode operations. The LLM system may obtain a prompt from an endpoint (e.g., a user), and cause the agents 102D-102H to begin generating the set of tokens, such as to generate a response to the prompt. The LLM system may provide the agents 102D-102H with prefill data or information to use as part of one or more decode operations to begin generating the set of tokens. The LLM system may provide information of the prompt to the agents 102D-102H to cause the agents 102D-102H to begin generating the set of tokens. The agents 102D-102H may perform one or more decode operations, or any suitable operation of a language model, such as those described herein, to begin generating the set of tokens.

The LLM system may then cause the agent 104A to perform one or more prefill operations of one or more tokens of the set of tokens before the set of tokens is completely generated. In some examples, as soon as a first token of the set of tokens is generated, the LLM system causes the agent 104A to perform a prefill operation using the first token. The system may cause the agent 104A to continuously perform prefill operations on tokens as the tokens are generated by the agents 102D-102H. The agent 104A may perform one or more prefill operations in parallel as one or more tokens are generated by the agents 102D-102H. As an illustrative example, the agents 102D-102H may generate two or more tokens in parallel (e.g., a first agent generates a first token, a second agent generates a second token, and so on), in which the agent 104A may perform two or more prefill operations in parallel using the two or more tokens (e.g., a first prefill operation on the first token in parallel with a second prefill operation on the second token).

The agent 104A may continue to perform the prefill operations until the agents 102D-102H have completely generated all tokens of the set of tokens. The set of tokens may be completely generated once the set of tokens comprises a particular number of tokens, which can be predefined or determined in any suitable manner. The set of tokens may be completely generated once each agent of the agents 102D-102H has generated a particular number of tokens, which can be predefined for each agent. Once the set of tokens is completely generated and the agent 104A has completed prefill operations on all of the tokens, the agent 104A may perform one or more decode operations to provide tokens for further processing (e.g., subsequent prefill operations by other agents) or otherwise output the tokens to be used to generate a response to the user.

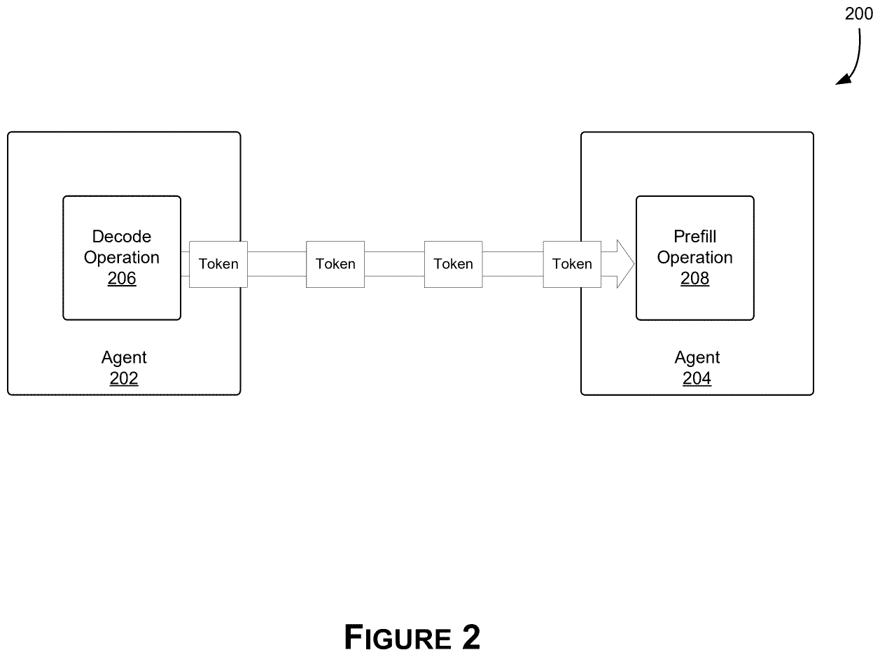

With reference to FIG. 2, FIG. 2 is an example dataflow from decode of one stage to another agent performing prefill for a next stage, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 6A-6C), one or more computing devices or components thereof (e.g., as described in FIG. 7), and/or one or more data centers or components thereof (e.g., as described in FIG. 8).

FIG. 2 may include agent 202 and/or agent 204, in which one or more tokens are provided as output of decode operation 206 of agent 202 to input to prefill operation 208 of agent 204. In some embodiments, agent 202 and/or 204 may operate in parallel with one or more other agents, in which tokens generated by multiple agents may be used as input to agent 204 in parallel. In some examples, tokens generated by agent 202 may be used as input to multiple agents.

Agent 202 may be described in connection with agents 102 of FIG. 1. Agent 204 may be described in connection with agents 104 of FIG. 1. In some embodiments, agent 202 and/or 204 perform decode operation 206, wherein the agent 202 and/or 204 generate output tokens based on prefilled input data. In some embodiments, agent 202 and/or 204 perform prefill operation 208, wherein data to be used in a decode operation is pre-processed or otherwise generated. Pre-processing of data can include data attenuation, cache creation, pre-computing elements of the LLM system processes, and/or any other suitable process to prepare data for LLM computation as part of a decode operation 206. In some embodiments, agent 202 performs as part of a prior stage (e.g., stage N 106, FIG. 1), whereas agent 204 performs as part of a sequentially next stage (e.g., stage N+1 108). Decode operation 206 may be performed in parallel with one or more other decode operations, wherein all parallel decode operations performed are of varying lengths performed on varying data. In such a case, a generated token output to prefill operation 208 may be collated into one or more prefill matrices (e.g., stage N outputs 306, FIG. 3) alongside other decode operation outputs. Collation of multiple decode operation outputs in a matrix may be a component operation of prefill operation 208, and/or performed separately.

An LLM system may cause the agent 202 to perform one or more decode operations to begin generating tokens of a set of tokens. The LLM system may provide data for the agent 202 to use to perform the decode operations or otherwise cause the agent 202 to perform prefill operations to generate data to be used to perform the decode operations. The agent 202 may perform decode operations until all tokens of the set of tokens are completely generated, which can be indicated by any suitable metric (e.g., the set of tokens includes a predefined number of tokens). As the tokens are being generated, the LLM system may provide the generated tokens to the agent 204 to perform one or more prefill operations. The LLM system, as the tokens are being generated, may cause the tokens to be stored in or otherwise streamed to one or more particular locations in memory (e.g., as part of a matrix or grid), which can be reserved or otherwise allocated to store the set of tokens. The agent 204 may retrieve or otherwise obtain the tokens from the particular locations as the tokens are being generated, and may perform prefill operations on the tokens. The agent 204 may perform prefill operations on a token as soon as the token is generated by the agent 202 until all tokens of the set of tokens are generated, in which the agent 204 may then perform decode operations or otherwise provide results of the prefill operations to one or more other agents or LLMs. In some examples, the agent 204 may perform decode operations to generate another set of tokens, in which another agent may perform prefill operations on tokens of the other set of tokens as the tokens are being generated by the agent 204.

With reference to FIG. 3, FIG. 3 is an example decode matrix allowing prefill of stage N+1 to be performed during decode of stage N, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 6A-6C), one or more computing devices or components thereof (e.g., as described in FIG. 7), and/or one or more data centers or components thereof (e.g., as described in FIG. 8).

FIG. 3 may include one or more agents 302D-302H (e.g., agents 302), error output 304, stage N outputs 306, stage N decode 308, and/or stage N+1 prefill 310. In some embodiments, agents 302 are described in connection with agents 102D-102H of FIG. 1. In an embodiment, stage N decode 308 is described in connection with decode operation 206 of FIG. 2 and stage N+1 prefill 310 is described in connection with prefill operation 208 of FIG. 2.

Error output 304 may be one or more outputs of agent 302F, wherein during incorporation of all outputs during stage N decode 308 an excess amount of output data was indicated to be incorporated into the prefill matrix from agent 302F. The prefill matrix, also referred to as a grid (e.g., comprising stage N outputs 306), may be sized based on expected output size of each agent to allow said agents 302 to output into the prefill matrix, with each slot or entry of the matrix being sized to allow output of one token per slot. The total size of the grid may be defined to be enough to store expected and/or predicted outputs of the agents 302 (e.g., contain enough storage to store the expected and/or predicted outputs). In some embodiments, outputs of the agents 302 may exceed expectations, resulting in error output 304. In some embodiments, if error output 304 is generated, the error output 304 is ignored and not passed to prefill of a next stage (e.g., prefill 310).

Stage N outputs 306 may be stored in the prefill matrix used to perform prefill of stage N+1 during decode of stage N. In some embodiments, each of agents 302 outputs to a corresponding row of the prefill matrix, outputting decode outputs to each slot of their matrix row in sequence as the agents perform in parallel. For example, for a given example matrix, each column of the matrix may correspond to the outputs of the agents at a given time slot. Referring to FIG. 3, by the third time slot, agent 302E has completed decode, and is no longer outputting data, and may fill matrix sections with ‘Blank’ to indicate a lack of outputs. However, other agents may still output tokens at this stage, filling their matrix rows with further outputs. In such a case, stage N+1 prefill 310 operations can be performed on given outputs of each time slot (e.g., during generation of stage N outputs 306). In some examples, entries, slots, or locations within the prefill matrix or grid may be referred to as storage locations and may be part of memory of or otherwise associated with one or more processing units, such as a graphics processing unit (GPU) or central processing unit (CPU).

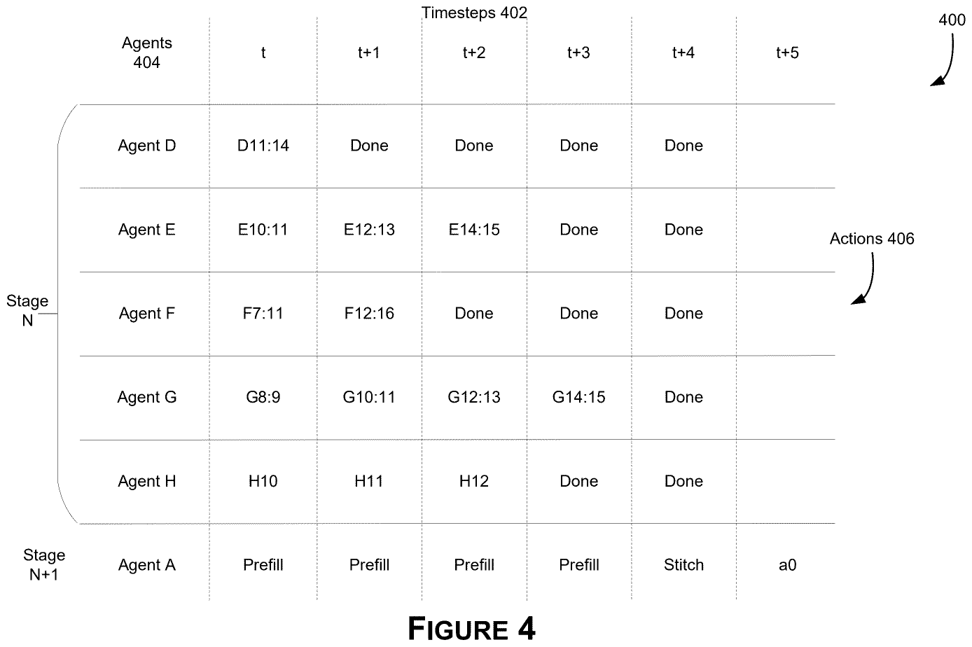

With reference to FIG. 4, FIG. 4 is an example set of agent tasks performed during each time slot of an example workflow, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 6A-6C), one or more computing devices or components thereof (e.g., as described in FIG. 7), and/or one or more data centers or components thereof (e.g., as described in FIG. 8).

FIG. 4 may include timesteps 402, agents 404, and/or actions 406. In some embodiments, agents 404 are described in connection with agents 302 of FIG. 3. Timesteps 402 may be indications of equal length, quantized portions of time during which agents 404 perform a portion of their task, such as generation of a token or processing of multiple prefill tokens. Each agent of agents 404, for each timestep 402, performs a particular task as indicated in FIG. 4. For example, during timestep t+2, agent E may have performed generation of tokens E14 and E15, outputting said tokens to a corresponding section of a prefill matrix. During the same timestep, thereby performing during the same length of time, agent D may have been idle, as it had already processed all indicated information and finished processing outputs.

Agent A, during timesteps t through t+3 (e.g., during which other agents are generating tokens), may perform prefill operations, as described by prefill operation 208 of FIG. 2. Said operations may be performed on outputs of a prior time step. For example, agent A prefill operations performed during timestep t+1 may be performed on all outputs of decode agents provided during timestep t. Upon completion of all decode agents (e.g., agents D-H), agent A may perform stitching operations. Stitching operations, indicated in FIG. 4 as “stitch,” may be one or more operations to provide attention between outputs of each row of the decision matrix. Prefill matrix data, due to being provided directly to prefill matrix slots, may have no attention (e.g., an indication of relevance of differing parts of the total dataset relative to each other) between outputs of differing agents. The stitch action may be performed to provide attention and prevent loss of data quality. Agent A may then proceed with its own decoding, as shown in timestep t+5, to generate an output token.

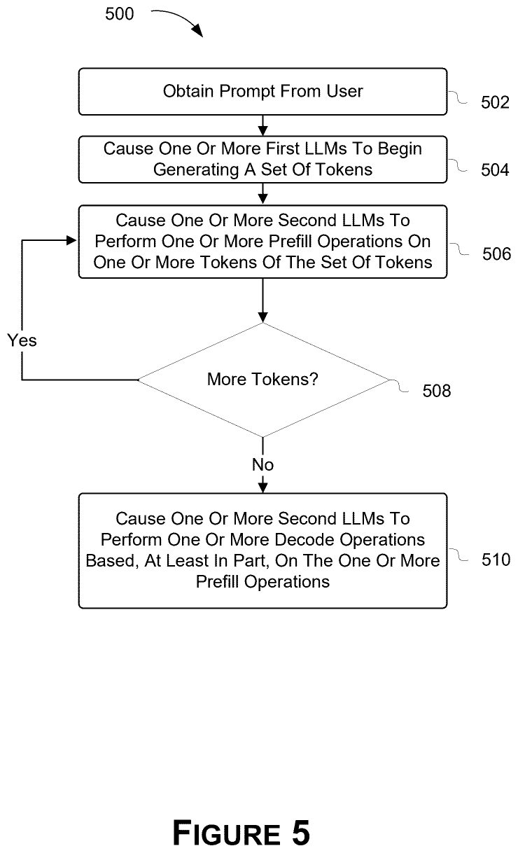

Now referring to FIG. 5, each block of method 500, described herein, comprises a computing process that may be performed using any combination of hardware, firmware, and/or software. For instance, various functions may be carried out using one or more processors (e.g., one or more GPUs and/or CPUs) executing instructions stored in one or more memories. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, method 500 is described, by way of example, with respect to the system of FIG. 1. However, this method may additionally or alternatively be executed by any one system, or any combination of systems, including, but not limited to, those described herein.

FIG. 5 is a flow diagram showing a method 500 for performing decode and prefill operations in accordance with some embodiments of the present disclosure. The method 500, at block 502, includes obtaining a prompt from a user. The prompt may be obtained from external memory, another LLM system, and/or any other viable data source. The prompt may be obtained via or otherwise in connection with an endpoint. The prompt may be obtained in connection with a user interface (e.g., hardware interface, software interface, and/or variations thereof), and may be implemented as text, audio, or image data. The user interface may be associated with any suitable hardware devices that may be utilized to process user input into the prompt. The prompt may include one or more requests from one or more users, such as requests to generate information, obtain information, process information, analyze information, and/or variations thereof. In an embodiment, the prompt may be any suitable question, statement, or any text that can be utilized by one or more LLMs to generate a relevant and coherent output.

The method 500, at block 504, includes causing one or more first LLMs to begin generating a set of tokens. The one or more first LLMs may be implemented in connection with one or more agents. In some examples, an LLM may refer to an agent that implements one or more LLMs. An LLM system may, based on the prompt, cause the one or more first LLMs to begin generating the set of tokens. The LLM system may provide information associated with the prompt to cause the one or more first LLMs to begin generating the set of tokens. The one or more first LLMs may perform one or more prefill operations and/or one or more decode operations such as those described herein to begin generating the set of tokens. The LLM system may cause the one or more first LLMs to generate tokens of the set of tokens into a particular storage area (e.g., a prefill matrix or grid).

The method 500, at block 506, includes causing one or more second LLMs to perform one or more prefill operations on one or more tokens of the set of tokens. The LLM system may cause the one or more second LLMs to perform prefill operations on tokens of the set of tokens as the tokens are generated by the one or more first LLMs. The prefill operations of block 506 may be performed in parallel with decode operations of block 504. The one or more second LLMs may perform the one or more prefill operations to generate prefill data to be used in one or more subsequent decode operations. The one or more second LLMs may obtain the tokens from the particular storage area as the tokens are being generated, and perform prefill operations on the tokens. The one or more second LLMs and the one or more first LLMs may be part of a single or multiple LLMs and/or LLM systems.

The method 500, at block 508, includes determining if there are more tokens that are being generated by the one or more first LLMs. The LLM system may determine whether the one or more first LLMs have completed generating tokens or otherwise completed performing one or more decode operations to generate the set of tokens. If further tokens are being generated, method 500 may iterate back to block 506 for the one or more second LLMs to continue to perform prefill operations on the tokens. If not, method 500 may iterate to block 510.

The method, at block 510, includes causing the one or more second LLMs to perform one or more decode operations based, at least in part, on the one or more prefill operations. The one or more second LLMs may utilize data generated from the one or more prefill operations to perform the one or more decode operations to generate one or more output tokens, which can be output to the user through a user interface, endpoint, and/or otherwise provided to other LLMs for further processing. In some examples, the LLM system may cause one or more stitching operations such as those described herein to be performed based on the one or more output tokens.

A neural network such as those described herein may be implemented as an agent that may implement or otherwise perform one or more processes of one or more neural networks, models, language models, and/or variations thereof. In some examples, a neural network is implemented as a set of instructions and data that can be utilized by a processor to perform operations of the neural network. A neural network may be caused to perform an operation or otherwise generate data by at least providing or otherwise indicating instructions and/or data to a processing unit and causing the processing unit to perform the instructions and/or use the data to perform one or more operations of the neural network, in which the instructions and/or data may encode parameters and other information and/or processes of the neural network. In some embodiments, an LLM such as described herein may be referred to as a neural network.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 6A is a block diagram of an example generative language model system 600 suitable for use in implementing at least some embodiments of the present disclosure. In the example illustrated in FIG. 6A, the generative language model system 600 includes a retrieval augmented generation (RAG) component 692, an input processor 605, a tokenizer 610, an embedding component 620, plug-ins/APIs 695, and a generative language model (LM) 630 (which may include an LLM, a SLM, a VLM, a multi-modal LM, etc.). The generative language model system 600 may be part of or otherwise implemented in connection with the LLM system as described in connection with FIG. 1-5.

At a high level, the input processor 605 may receive an input 601 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 630 (e.g., LLM/SLMs/VLM/MMLM/etc.). In some embodiments, the input 601 includes plain text in the form of one or more sentences, paragraphs, and/or documents. Additionally or alternatively, the input 601 may include numerical sequences, precomputed embeddings (e.g., word or sentence embeddings), and/or structured data (e.g., in tabular formats, JSON, or XML). In some implementations in which the generative LM 630 is capable of processing multi-modal inputs, the input 601 may combine text (or may omit text) with image data, audio data, video data, design data, USD data, and/or other types of input data, such as but not limited to those described herein. Taking raw input text as an example, the input processor 605 may prepare raw input text in various ways. For example, the input processor 605 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 605 may remove stopwords to reduce noise and focus the generative LM 630 on more meaningful content. The input processor 605 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 692 (which may include one or more RAG models, and/or may be performed using the generative LM 630 itself) may be used to retrieve additional information to be used as part of the input 601 or prompt. RAG may be used to enhance the input to the LLM/SLM/VLM/MMLM/etc. with external knowledge, so that answers to specific questions or queries or requests are more relevant—such as in a case where specific knowledge is required. The RAG component 692 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 601 may be generated using the query or input to the model (e.g., a question, a request, etc.) in addition to data retrieved using the RAG component 692. In some embodiments, the input processor 605 may analyze the input 601 and communicate with the RAG component 692 (or the RAG component 692 may be part of the input processor 605, in embodiments) in order to identify relevant text and/or other data to provide to the generative LM 630 as additional context or sources of information from which to identify the response, answer, or output 690, generally. For example, where the input indicates that the user is interested in a desired tire pressure for a particular make and model of vehicle, the RAG component 692 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 692 may retrieve a prior stored conversation history—or at least a summary thereof—and include the prior conversation history along with the current ask/request as part of the input 601 to the generative LM 630.

The RAG component 692 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 692 and the embeddings of the chunks along with the embeddings of the query may be compared to identify the most similar/related embeddings to the query, which may be supplied to the generative LM 630 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 692 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 610 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 630 to understand morphological variations and handle out-of-vocabulary words more effectively. Character-based tokenization represents each character as a separate token, enabling the generative LM 630 to process text at a fine-grained level. The choice of tokenization strategy may depend on factors such as the language being processed, the task at hand, and/or characteristics of the training dataset. As such, the tokenizer 610 may convert the (e.g., processed) text into a structured format according to tokenization schema being implemented in the particular embodiment.

The embedding component 620 may use any known embedding technique to transform discrete tokens into (e.g., dense, continuous vector) representations of semantic meaning. For example, the embedding component 620 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 601 includes image data/video data/etc., the input processor 601 may resize the data to a standard size compatible with format of a corresponding input channel and/or may normalize pixel values to a common range (e.g., 0 to 1) to ensure a consistent representation, and the embedding component 620 may encode the image data using any known technique (e.g., using one or more convolutional neural networks (CNNs) to extract visual features). In some implementations in which the input 601 includes audio data, the input processor 601 may resample an audio file to a consistent sampling rate for uniform processing, and the embedding component 620 may use any known technique to extract and encode audio features—such as in the form of a spectrogram (e.g., a mel-spectrogram). In some implementations in which the input 601 includes video data, the input processor 601 may extract frames or apply resizing to extracted frames, and the embedding component 620 may extract features such as optical flow embeddings or video embeddings and/or may encode temporal information or sequences of frames. In some implementations in which the input 601 includes multi-modal data, the embedding component 620 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 630 and/or other components of the generative LM system 600 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 620 may apply an encoded representation of the input 601 to the generative LM 630, and the generative LM 630 may process the encoded representation of the input 601 to generate an output 690, which may include responsive text and/or other types of data.

As described herein, in some embodiments, the generative LM 630 may be configured to access or use—or capable of accessing or using—plug-ins/APIs 695 (which may include one or more plug-ins, application programming interfaces (APIs), databases, data stores, repositories, etc.). For example, for certain tasks or operations that the generative LM 630 is not ideally suited for, the model may have instructions (e.g., as a result of training, and/or based on instructions in a given prompt, such as those retrieved using the RAG component 692) to access one or more plug-ins/APIs 695 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 695 to the plug-in/API 695, the plug-in/API 695 may process the information and return an answer to the generative LM 630, and the generative LM 630 may use the response to generate the output 690. This process may be repeated —e.g., recursively—for any number of iterations and using any number of plug-ins/APIs 695 until an output 690 that addresses each ask/question/request/process/operation/etc. from the input 601 can be generated. As such, the model(s) may not only rely on its own knowledge from training on a large dataset(s) and/or from data retrieved using the RAG component 692, but also on the expertise or optimized nature of one or more external resources—such as the plug-ins/APIs 695.

FIG. 6B is a block diagram of an example implementation in which the generative LM 630 includes a transformer encoder-decoder. For example, assume input text such as “Who discovered gravity” is tokenized (e.g., by the tokenizer 610 of FIG. 6A) into tokens such as words, and each token is encoded (e.g., by the embedding component 620 of FIG. 96A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 635 of the generative LM 630.

In an example implementation, the encoder(s) 635 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 640 may convert the context vector into attention vectors (keys and values) for the decoder(s) 645.

In an example implementation, the decoder(s) 645 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 635, in an example transformer architecture, each token (e.g., word) flows through a separate path in the decoder(s) 645. During a first pass, the decoder(s) 645, a classifier 650, and a generation mechanism 655 may generate a first token, and the generation mechanism 655 may apply the generated token as an input during a second pass. The process may repeat in a loop, successively generating and adding tokens (e.g., words) to the output from the preceding pass and applying the token embeddings of the composite sequence with positional encodings as an input to the decoder(s) 645 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 635, except that it creates its queries from the layer below it and takes the keys and values (e.g., matrix) from the output of the encoder(s) 635.

As such, the decoder(s) 645 may output some decoded (e.g., vector) representation of the input being applied during a particular pass. The classifier 650 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 655 may select or sample a word or token based on a corresponding predicted probability (e.g., select the word with the highest predicted probability) and append it to the output from a previous pass, generating each word or token sequentially. The generation mechanism 655 may repeat the process, triggering successive decoder inputs and corresponding predictions until selecting or sampling a symbol or token that represents the end of the response, at which point, the generation mechanism 655 may output the generated response.

FIG. 6C is a block diagram of an example implementation in which the generative LM 630 includes a decoder-only transformer architecture. For example, the decoder(s) 660 of FIG. 6C may operate similarly as the decoder(s) 645 of FIG. 6B except each of the decoder(s) 660 of FIG. 6C omits the encoder-decoder self-attention layer (since there is no encoder in this implementation). As such, the decoder(s) 660 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 660. As with the decoder(s) 645 of FIG. 6B, each token (e.g., word) may flow through a separate path in the decoder(s) 660, and the decoder(s) 660, a classifier 665, and a generation mechanism 670 may use auto-regression to sequentially generate one token at a time until predicting a symbol or token that represents the end of the response. The classifier 665 and the generation mechanism 670 may operate similarly as the classifier 650 and the generation mechanism 655 of FIG. 6B, with the generation mechanism 670 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof. The computing device(s) 700 may be part of or otherwise implemented in connection with the LLM system as described in connection with FIG. 1-5. In some examples, the computing device(s) 700 may implement the LLM system as described in connection with FIG. 1-5.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). As such, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)-which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that allow the computing device 700 to communicate with other computing devices via an electronic communication network, included wired and/or wireless communications. The communication interface 710 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may allow the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that allow detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to allow the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Example Data Center

FIG. 8 illustrates an example data center 800 that may be used in at least one embodiments of the present disclosure. The data center 800 may include a data center infrastructure layer 810, a framework layer 820, a software layer 830, and/or an application layer 840. The data center 800 may be part of or otherwise implemented in connection with the LLM system as described in connection with FIG. 1-5. In some examples, the data center 800 may implement the LLM system as described in connection with FIG. 1-5.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-8161(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 828, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may use distributed file system 838 for large-scale data processing (e.g., “big data”). In at least one embodiment, job scheduler 828 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 828. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
cause one or more first neural networks to begin generating a set of tokens; and
cause one or more second neural networks to perform one or more prefill operations on a first token of the set of tokens in parallel with the generation of a subsequent token of the set of tokens.

2. The one or more processors of claim 1, wherein the processing circuitry is to cause the one or more second neural networks to perform the one or more prefill operations on tokens of the set of tokens in parallel.

3. The one or more processors of claim 1, wherein the processing circuitry is to cause the one or more first neural networks to perform one or more decode operations to generate the set of tokens.

4. The one or more processors of claim 1, wherein the processing circuitry is to cause the one or more second neural networks to perform one or more decode operations after the one or more first neural networks generate the set of tokens.

5. The one or more processors of claim 1, wherein the one or more first neural networks include one or more language models.

6. The one or more processors of claim 1, wherein the processing circuitry is to cause the one or more first neural networks to generate the set of tokens in one or more storage locations.

7. The one or more processors of claim 1, wherein the processing circuitry is to cause the one or more second neural networks to generate one or more output tokens based, at least in part, on the set of tokens.

8. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLMs);
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

9. A system comprising one or more processors to:
cause one or more first neural networks to begin generating a set of tokens based, at least in part, on one or more prompts; and
cause one or more second neural networks to perform one or more prefill operations on a token of the set of tokens while the set of tokens is being generated.

10. The system of claim 9, wherein the one or more processors are to cause the one or more first neural networks to perform one or more decode operations to generate one or more tokens of the set of tokens.

11. The system of claim 9, wherein the one or more processors are to, after the set of tokens is completely generated, cause the one or more second neural networks to perform one or more decode operations to generate another set of tokens.

12. The system of claim 9, wherein the one or more processors include one or more graphics processing units (GPUs).

13. The system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLMs);
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

14. A method comprising:
obtaining one or more prompts;
causing one or more first neural networks to generate one or more tokens of a set of tokens based, at least in part, on the one or more prompts; and
causing one or more second neural networks to perform one or more prefill operations on the one or more tokens before the set of tokens is completely generated.

15. The method of claim 14, wherein the one or more first neural networks are to generate two or more tokens of the set of tokens in parallel.

16. The method of claim 14, further comprising causing the one or more first neural networks to generate the one or more tokens into a grid of a defined size.

17. The method of claim 14, wherein the one or more second neural networks include one or more language models.

18. The method of claim 14, further comprising causing the one or more second neural networks to obtain the one or more tokens from a grid to perform the one or more prefill operations.

19. The method of claim 14, further comprising obtaining the one or more prompts in connection with one or more user interfaces.

20. The method of claim 14, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLMs);
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.
